(19) United States
(12) Patent Application Publication
(10) Pub. No.: US 2008/0179158 A1
(43) Pub. Date: Jul. 31, 2008

(54) HYDRAULIC DOUBLE CLUTCH

(76) Inventor: Filip De Maziere, Heusden-Destelbergen (BE)

Correspondence Address: MICHAEL BEST & FRIEDRICH LLP, 100 E WISCONSIN AVENUE, Suite 3300, MILWAUKEE, WI, 53202, US

(21) Appl. No.: 11/937,816

(22) Filed: Nov. 9, 2007

(30) Foreign Application Priority Data
May 9, 2005 (EP) 05010078.3
May 9, 2006 (EP) PCT/EP2006/004342

(51) Int. Cl. F16D 25/10

(52) U.S. Cl. 192/58.6

(57) ABSTRACT

A double clutch of a double clutch transmission of an engine is shown and described, and can comprise two clutch packs associated to two coaxial shafts, two clutch pistons each activating one of the clutch packs, and a hydraulic control device including a low pressure pump for lubrication and cooling of the clutch plates of the clutch packs, and a high pressure pump for activation of the clutch piston and a synchronizer. The low pressure pump and the high pressure pump can be disposed in parallel. Also, an electronic control device can control the hydraulic control system. In some embodiments, a flow switch is provided in a low engine speed range, and is adapted to combine oil flow of the low pressure pump and the high pressure pump at high pressures.

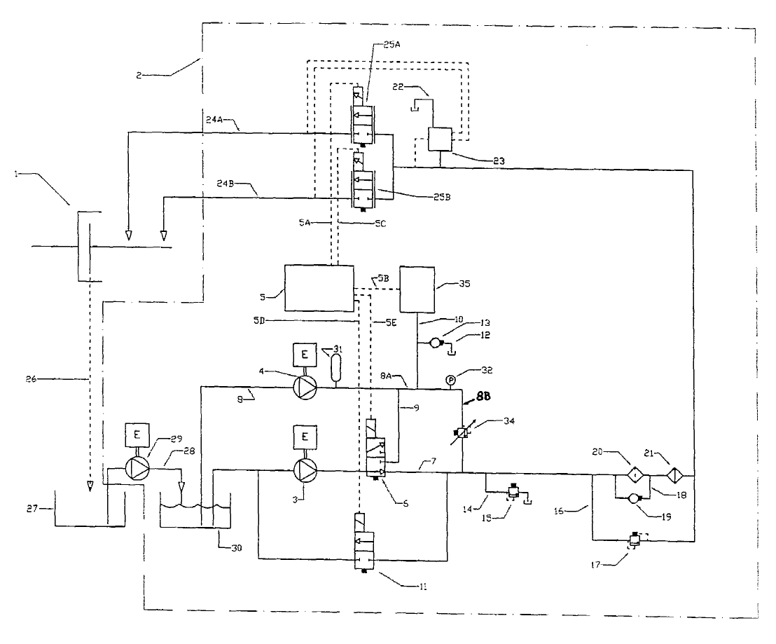

### CROSS-REFERENCE TO RELATED APPLICATIONS

This is a continuation of international patent application number PCT/EP2006/004342 filed on May 9, 2006, and claims priority to European Patent App. No. 05010078.3 filed on May 9, 2005. The entire contents of both prior-filed patent applications are incorporated herein by reference.

### BACKGROUND

The present invention relates to power supplies for hydraulic double clutches. An example of such a double clutch is disclosed in EP 1 195 537 B1, the entire content of which is incorporated herein by reference insofar as it relates to double clutches and power supplies for double clutches.

As the pump flow of hydraulic control device pumps of known double clutches is dependent on engine speed, known double clutches suffer from the drawback that sufficient oil pressure and supply can be difficult to achieve, especially for quick shifts and in cases where the engine is running in a low engine speed range.

### SUMMARY

It is an object of the present invention to provide a double clutch that is particularly able to perform quick shifts even at low engine speed without consuming excessive power over the whole speed range of the engine.

According to some embodiments of the present invention, a double clutch of a clutch transmission for an engine (e.g., an internal combustion engine) includes a hydraulic control device having a low pressure pump as well as a high pressure pump.

Moreover, the double clutch according to some embodiments of the present invention comprises a flow switch that is able to connect the high pressure pump and the low pressure pump in low engine speed ranges. In so doing, oil flow of the low pressure pump as well as the high pressure pump can be combined to create an enhanced oil flow (at raised oil pressures) that is fed to the clutch pistons of the clutch packs of the double clutch so that the clutch pistons can selectively be activated. This capability can enable performance of quick shifts, and can provide a sufficient oil pressure level even in low engine speed ranges. This raised oil flow at high pressure is also used to move the pistons of shift forks. Since it is also typically important that these forks are moved fast, high oil pressure and flow are needed simultaneously.

The flow switch can take the form of an appropriate hydraulic shift valve. In some embodiments, this hydraulic shift valve is preferable an on-off valve having 2 positions:
adding the flow of the low pressure pump to the flow of the high pressure pump; and
separating the flows: the flow from the low pressure pump being used for lubrication of the clutches, and the flow of the high pressure pump being used for the high pressure control valve.

In any case, excess flow from the high pressure control valve can be used for cooling purposes, and can be returned to the low pressure line.

In some embodiments, the flow switch is preferably located in the low pressure line downstream of the low pressure pump, creating a flow connection of the low pressure pump either to the cooling lines or the high pressure lines. Also, in some embodiments, when the switch connects the flow of the low pressure pump to the high pressure system, the low pressure lines are blocked to prevent the low pressure oil from leaking away.

Of course, if there is sufficient oil pressure, the flow switch need not be operated, so that the low pressure pump can normally serve the purpose of lubrication, while the high pressure pump serves the purpose of activating the clutch pistons of the double clutch and the pistons for synchronizer activation in all engine speed ranges, thereby ensuring a sufficiently high oil pressure level.

At even higher engine speeds, or when not much cooling flow toward the clutches is needed, another valve can switch the flow of the low pressure pump to a tank or to the suction of the low pressure pump. In doing so, the low pressure pump consumes almost no mechanical power, in some embodiments. Accordingly, this valve is an optional device meant for further reduction of power consumption.

In some embodiments, a pressure regulator for adjusting the pressure level depending on how much torque has to be transmitted is preferably provided.

Also, in some embodiments, two variable flow regulators are preferably provided, can be electronically controlled, and adjust the amount of oil provided to the two clutches of the double clutch according to the present invention, taking into account the respective operating conditions of the clutch and the engine.

In some embodiments, a flow limiter limits the total oil flow to both clutches in the event that no hydraulic fluid or only a low amount of hydraulic fluid (e.g., oil) is needed. The flow limiter can be a differential pressure regulator keeping the pressure drop over the flow regulators constant. This feature is meant to limit the pressure in the cooling lines so that the low pressure pump woks at a lower pressure, and thus consumes less power.

Further features and advantages of the present application will become apparent from the following description of preferred embodiments, with reference to the appended drawing.

### BRIEF DESCRIPTION OF THE DRAWING

This accompanying FIGURE shows a schematically simplified block diagram of a hydraulic double clutch according to an embodiment of the present invention.

### DETAILED DESCRIPTION

The accompanying FIGURE shows a schematically simplified double clutch 1 comprising components of known hydraulic double clutches. In particular, the double clutch 1 comprises two clutch packs associated with coaxial shafts (not shown) and clutch pistons for activating the clutch discs of the clutch packs. For further information regarding these known components, reference is hereby made to EP 1 195 537 B1, the entire content of which is incorporated by reference insofar as it relates to double clutches and power supplies for double clutches.

The illustrated double clutch 1 comprises a hydraulic control device 2 that is an arrangement of all hydraulic components surrounded by the dash-dotted line in the accompanying FIGURE (designated by reference number 2).

The illustrated hydraulic control device 2 includes a low pressure pump 3 for lubrication and cooling of the clutch plates of the clutch packs of the double clutch 1.

Moreover, the illustrated hydraulic control system 2 comprises a high pressure pump 4 for activation of the clutch piston of the clutch packs and the synchronizers (not shown in the accompanying FIGURE).

As can be seen from the FIGURE, pumps 3 and 4 are arranged in parallel in a low pressure line 7 and a high pressure line 8, respectively. Double clutch 1 and the hydraulic control device 2, respectively, are controlled by an electronic control unit 5 supplied with all necessary signals from double clutch 1, hydraulic components of the hydraulic control system 2, as well as the engine. The electronic control unit 5 is connected via control lines to all components of the entire system to be controlled, with dotted lines 5A-5D being examples of respective control lines.

The illustrated hydraulic control device 2 also comprises a flow switch 6. In some embodiments, the flow switch is preferably disposed in low pressure line 7 downstream of the low pressure pump 3. The flow switch 6 is adapted to connect the low pressure pump 3 and the high pressure pump 4 in the event that the engine is running in a low engine speed range, thereby providing a sufficiently high oil flow at high pressure to the double clutch 1, especially in cases where quick shifting is needed. With continued reference to the accompanying FIGURE, the illustrated flow switch 6 is disposed in a connection line 9. A suitable flow connection for high pressure oil flow is provided by connection line 9, line section 8A of the high pressure line 8, and a connection line 10 via a hydraulic control valve 35. This flow arrangement provides a flow connection to the clutch pistons (not shown) operating the clutch packs (also not shown) of the hydraulic double clutch 1.

As also shown in the accompanying FIGURE, a high pressure drain line 12 branches from the connection line 10, and is provided with a high pressure safety valve 13. Moreover, a low pressure drain line 14 branching off the low pressure line 7 is provided with a low pressure safety valve 15.

With reference to the accompanying FIGURE, in some embodiments a pressure regulator line 16 branches off the low pressure line 7 downstream of the low pressure line 14, and comprises a differential pressure regulator 17. This regulator is added to limit the pressure at the pump at high speeds, and can reduce power consumption.

From low pressure line 7, a short circuit switch 11 can optionally be added, and can be selected to send all the flow of the low pressure pump 3 back to its suction. This short circuiting of the flow can bring power consumption of the low pressure pump 3 almost to zero. In some embodiments, the short circuit switch 11 is used at high engine speeds when the high pressure pump 4 is delivering sufficient flow to the cooling low pressure line 7.

A filter 20 can also be provided in the low pressure line 7. As shown in the accompanying FIGURE, a bypass line 18 can be provided parallel to the filter 20, and can comprise a bypass valve 19. The bypass line 18 bypasses the filter 20 in the low pressure line 7. Downstream of the filter, a cooler 21 can be provided.

With continued reference to the illustrated embodiment, a flow limiter 23 can be provided downstream of the cooler 21. The flow limiter 23 can be disposed in line or in parallel (as shown) to the low pressure line 7, and is adapted to limit the total amount of oil flow to both clutch packs of the double clutch 1 in the event that there is no need or a low need of oil. Accordingly, the illustrated flow limiter 23 is connected to a flow limiter drain line 22.

In some embodiments, two flow regulators 25A, 25B are disposed in the low pressure line 7, and comprise the flow lines 24A, 24B to the double clutch 1. The flow regulators 25A, 25B can adjust the amount of oil provided to the two clutch packs of the double clutch 1 according to respective operating conditions.

Oil exiting the clutch can be collected in a sump 27, as represented by the dotted line 26 in the accompanying FIGURE. In some embodiments, this sump 27 is a dry sump 27 that, in turn, is connected via a wet sump line 28 to a wet sump 30. Also, in some embodiments, a scavenging pump 29 is disposed in the wet sump line 28, and provides a flow connection between the dry sump 27 and the wet sump 30.

As an optional feature, a damper 31 can be provided downstream of the high pressure pump 4 in the high pressure line 8.

For the sake of completeness, it should be noted that a suitable number of sensors (e.g., pressure sensor 32) can also be part of the hydraulic control device 2. Finally, a variable pressure regulator 34 can be disposed in a line section 8B of the high pressure line 8 downstream of the high pressure pump 4. Such a variable pressure regulator 34 can be adapted to adjust the pressure level depending upon the amount of torque that must be transmitted by the double clutch 1.

In addition to the written description, explicit reference is hereby made to the single FIGURE of the drawing for the purpose of disclosure of all elements and features of the double clutch 1 according to the present invention, and its hydraulic control device 2, respectively.

What is claimed is:

1. A double clutch of a double clutch transmission of an engine, the double clutch comprising:
two clutch packs coupled to two shafts;
two clutch pistons, each of which activate one of the clutch packs;
a hydraulic control device comprising:
a low pressure pump for lubrication and cooling of clutch plates of the clutch packs; and
a high pressure pump for activation of the clutch pistons and a synchronizer;
wherein the low pressure pump and the high pressure pump are disposed in parallel;
an electronic control device controlling the hydraulic control system; and
a flow switch that, in a low engine speed range, is adapted to combine oil flow of the low pressure pump and the high pressure pump.

2. The double clutch as claimed in claim 1, wherein the flow switch is disposed in a low pressure line downstream of the low pressure pump.

3. The double clutch as claimed in claim 1, further comprising a pressure regulator adjusting an oil pressure level upstream of the pressure regulator depending at least in part upon at least one of an amount of torque to be transmitted and a desired shift time.

4. The double clutch as claimed in claim 2, further comprising a pressure regulator adjusting an oil pressure level upstream of the pressure regulator depending at least in part upon at least one of an amount of torque to be transmitted and a desired shift time.

5. The double clutch as claimed in claim 1, further comprising two flow regulators adapted to adjust an amount of oil provided to the clutch packs according to respective operating conditions of the clutch packs.

6. The double clutch as claimed in claim 2, further comprising two flow regulators adapted to adjust an amount of oil provided to the clutch packs according to respective operating conditions of the clutch packs.

7. The double clutch as claimed in claim 3, further comprising two flow regulators adapted to adjust an amount of oil provided to the clutch packs according to respective operating conditions of the clutch packs.

8. The double clutch as claimed in claim 1, further comprising a flow limiter limiting a total amount of oil flow to the clutch packs responsive to at least one of a condition in which no need of oil exists and a condition in which a low threshold of oil need is reached.

9. The double clutch as claimed in claim 2, further comprising a flow limiter limiting a total amount of oil flow to the clutch packs responsive to at least one of a condition in which no need of oil exists and a condition in which a low threshold of oil need is reached.

10. The double clutch as claimed in claim 3, further comprising a flow limiter limiting a total amount of oil flow to the clutch packs responsive to at least one of a condition in which no need of oil exists and a condition in which a low threshold of oil need is reached.

11. The double clutch as claimed in claim 5, further comprising a flow limiter limiting a total amount of oil flow to the clutch packs responsive to at least one of a condition in which no need of oil exists and a condition in which a low threshold of oil need is reached.

12. The double clutch as claimed in claim 11, wherein the flow limiter cooperates with the flow regulators.

13. A hydraulic control device comprising a double clutch according to claim 1.

14. A hydraulic control device comprising a double clutch according to claim 2.

15. A hydraulic control device comprising a double clutch according to claim 3.

16. A hydraulic control device comprising a double clutch according to claim 5.

17. A hydraulic control device comprising a double clutch according to claim 8.
